(19) United States
(12) Patent Application Publication
(10) Pub. No.: US 2012/0104122 A1
(43) Pub. Date: May 3, 2012

(54) Long Reach Impingement Nozzle For Use In Robotic Water Cleaning Systems

(76) Inventors: Stephen J. Laski, Howell, MI (US); Kirk A. Morrow, Waterford, MI (US); Dean E. Allen, Gaines, MI (US); Jeffrey M. Connell, Imlay City, MI (US)

(21) Appl. No.: 13/234,650

(22) Filed: Sep. 16, 2011

Related U.S. Application Data
(60) Provisional application No. 61/383,366, filed on Sep. 16, 2010.

(51) Int. Cl. B05B 1/00

(52) U.S. Cl. 239/589

(57) ABSTRACT

A water cleaning nozzle and more specifically, a long reach water cleaning nozzle for accessing narrow and small places within a manufactured part.

### CROSS REFERENCE TO RELATED APPLICATION

This utility patent application claims the priority of U.S. Provisional Patent Application Ser. No. 61/383,366 filed on Sep. 16, 2010, entitled “Long Reach Impingement Nozzle For Use In Robotic Water Cleaning Systems,” the entire disclosure of the application being considered part of the disclosure of this application and hereby incorporated by reference.

### BACKGROUND OF THE INVENTION

1. Technical Field

The present invention is directed to a water cleaning nozzle and more specifically, a long reach water cleaning nozzle for accessing narrow and small places deep within a manufactured part, such as a cast part and more specifically, a turbine.

2. Related Art

Currently, there is a lack of long reach water cleaning nozzles able to reach deep into small openings, while providing accurate placement of spray. Some issues experienced with long reach water nozzles formed from a narrow diameter tube is that under pressure the nozzle may bend or bow, thereby changing the expected area of impingement of the water and reducing accuracy. Any reduction in accuracy may cause spots to be missed. In some circumstances, if the water is cycled off and on while the nozzle is inserted into the part, the bending motion may cause undesirable contact with the part. Also, all current nozzles able to access well into a part through narrow openings must be replaced regularly at great expense due to their design characteristics and currently none have replaceable nozzle tips that allow only the orifice eto be replaced when it wears out.

Another issue with current nozzles is that the water passing through the nozzle experiences turbulence, pressure variations and therefore does not exit the nozzle tip cleanly. This provides less than desirable spray patterns, and in particular, reduced cleaning efficiency.

### SUMMARY OF THE INVENTION

The present invention is directed to a water cleaning nozzle having elongated nozzle body and a removeable nozzle tip including the orifice. The nozzle body is formed in an elongated shape having a tapered portion extending to a narrow and small cross section near the nozzle tip which allows access to hard to reach locations for high pressure water cleaning.

The present invention uses the nozzle body which has a tapered portion and an elongated portion extended therefrom with a nozzle tip attached to the far end of the elongated portion. The nozzle body also includes an interior cavity that has tapered inner walls that reduce in size before extending predominantly along a substantially unchanging diameter for the greater portion of the nozzle body. The transition between the tapered inner walls and the non-tapered inner walls is specifically configured to occur within the tapered portion of the nozzle body.

The nozzle tip is configured to be replaceable and is coupled to the nozzle body. The nozzle tip generally includes an attachment portion with interior passages or inner cavities that extend to an orifice which provides the pattern of spray. The nozzle tip also includes tapered inner tip walls that taper to an orifice.

### DESCRIPTION OF THE FIGURES

FIG. 1 is a perspective view of nozzle;

FIG. 2 is a first side view of the nozzle;

FIG. 3 is a second side view of the nozzle;

FIG. 4 is a first end view of the nozzle;

FIG. 5 is a second end view of the nozzle;

FIG. 6 is a cross sectional view of a nozzle body of the nozzle in FIG. 2 along lines 6-6; and

FIG. 7 is a cross sectional view of the nozzle tip of the nozzle in FIG. 2 along lines 7-7.

### DETAILED DESCRIPTION OF THE PREFERRED EMBODIMENT

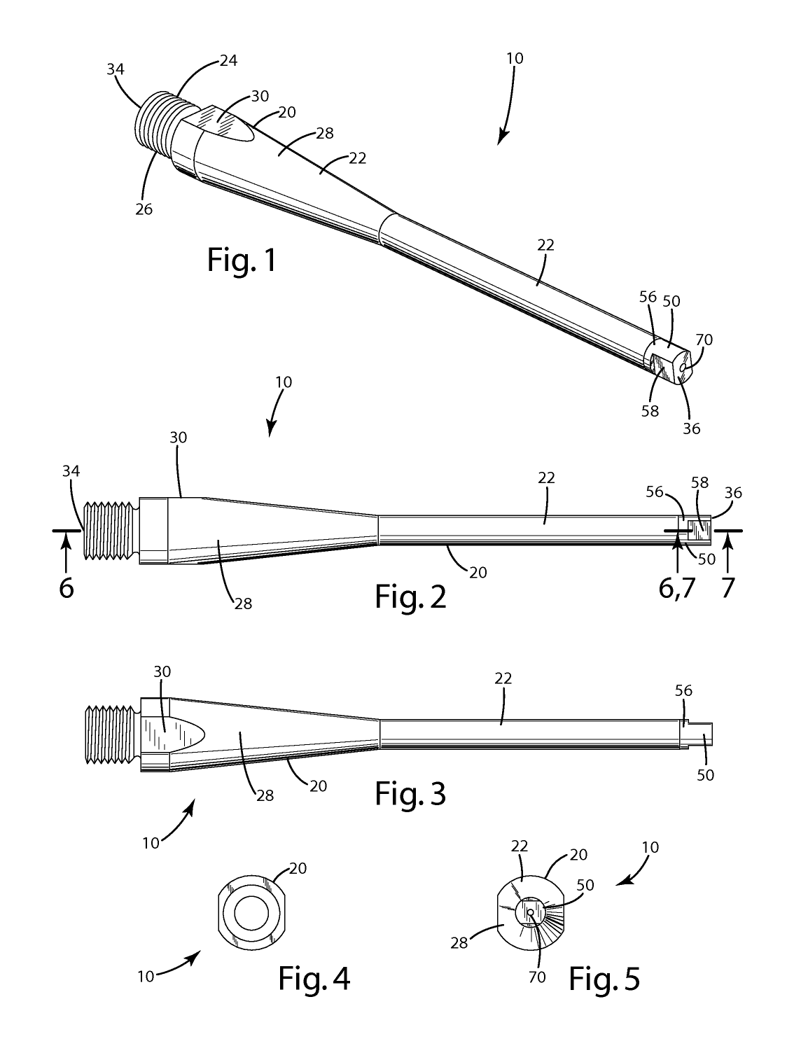

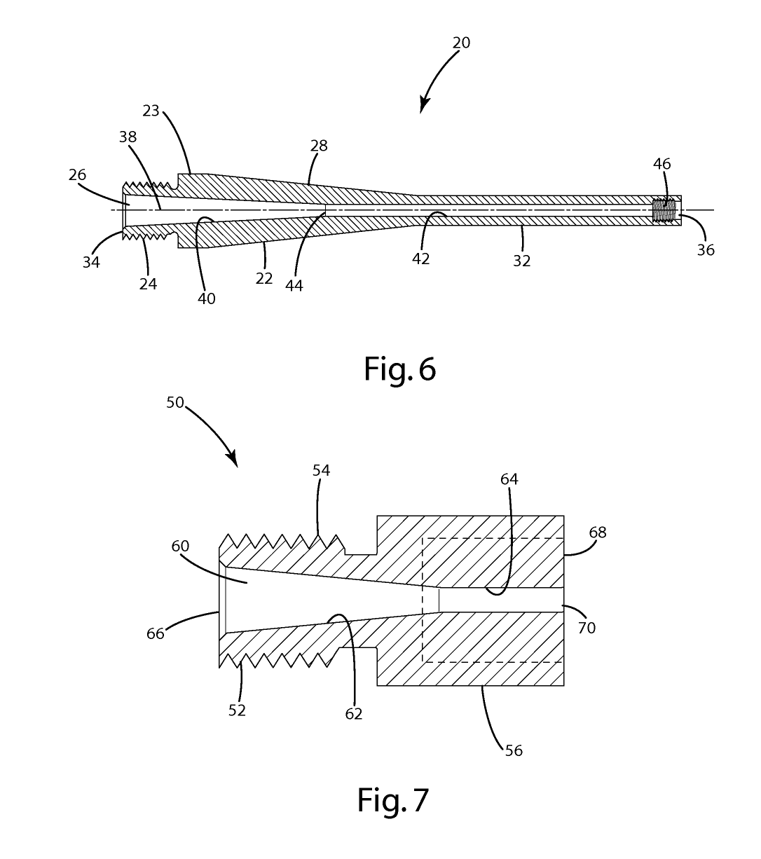

The present invention is generally directed to a nozzle 10 as illustrated in the Figures. The nozzle 10 is specifically configured for an elongated reach into narrow or small openings on various manufactured parts and is specifically designed for water cleaning applications. Water cleaning applications typically use a pressure of 3,000 to 20,000 psi as compared to water cutting applications which use pressures in the excess of 40,000 psi. The nozzle 10 illustrated in FIGS. 1-5 generally further includes a nozzle body 20 which is specifically illustrated in FIGS. 6-8 and a nozzle tip 50 which is specifically illustrated in FIGS. 9-10.

The nozzle body 20 is formed out of a single member and generally includes an outer surface 22 and an inner cavity 38 extending therethrough. The outer surface 22 of the nozzle body 20 is specifically configured to minimize bowing or bending under pressure while still providing a minimal cross section area to allow the nozzle 10 to extend deep into hard to reach locations and through small openings. In some circumstances the openings are overall not small but due to the configuration of the workpiece, such as a turbine, had to reach inside without the nozzle of the present invention. The nozzle body 20 generally includes an attachment portion 24 which attaches to the end effector typically of a robot or a CNC machine (not illustrated). The attachment portion 24 may use any desirable method of attachment to an end effector but is typically accomplished through a threaded portion 26 as illustrated in FIGS. 1-3 and 8. Extending from the attachment portion 24 is the tapered portion 28 which engages the end effector and then tapers at about a 4°-25° angle and preferably above a 12° angle in a reducing diameter as it extends away from the attachment portion 24. The tapered portion 28 may include wrench surfaces 30 in some embodiments which allow for easy installation and removal from the end effector (not illustrated). From the tapered portion 28, an elongated portion 32 extends to an exit end 36. The elongated portion 32 is generally of consistent diameter along its length although minor variations may occur and a very minor taper of course could also occur. The elongated portion 32 is illustrated to have a length of approximately 45-75% and more specifically, 50-65% of the overall length of the nozzle body 20.

The nozzle body 20 includes an entrance end 34 proximate to the threaded portion 36 or attachment portion 24 and an exit end 36 which is proximate to a threaded end portion 36 where the nozzle tip 50 is installed. Extending between the entrance end 34 and exit end 36 is an interior cavity 38.

The interior or inner cavity 38 includes tapered inner walls 40 for at least a portion of the inner cavity 38. Extending from the tapered inner walls 40 is an elongated inner cavity wall 42. The elongated inner cavity wall 42 generally has a substantially consistent or slightly reducing diameter. In comparison, the tapered inner walls 40 generally are reducing at an approximately 2° angle as they extend into the nozzle body from the entrance end 34. As illustrated in FIG. 6, a transition 44 may be seen between the tapered inner walls 40 and the elongated cavity walls 42. It is important to note that this transition 44 occurs within the tapered portion 28 of the nozzle body 20. As the walls 40 taper, pressure and velocity may change which by placing the transition 44 within the thicker tapered portion 28 minimizes any effects of bowing or bending from the tapered inner walls 40. The elongated cavity 38 extends to the threaded end portion 46 which is illustrated as a female end but of course could be a male end in some embodiments.

The tapered inner walls 40 extend starting within the attachment portion to the transition point 44 which occurs within the tapered portion 28. The elongated cavity walls 42 extend at least 20% preferably 30% and more preferably, at least 40% into the tapered portion 28, or that the transition point 44 is located that distance from the transition of the tapered portion 28 to the elongated portion 32. It has been found that approximately 40.5%, ±2% works well. Of course, the above numbers could change if inner walls 40 within the attachment portion 24 were not tapered, the type of material was changed, or the relative angles, but it is expected that they would be close. In no event would the location of the transition point be spaced more than 60% from the outer transition point 29, preferably less than 50%. However, if the round portion 23 was eliminated, and the tapered portion 28 extended to the attachment portion 24, then the transition point 44 would be set back from the outer transition point 29 by at least 18%, preferably 25%, and more preferably at least 30% of the total tapered portion 28.

The nozzle tip 50 may be generally any nozzle tip having similar dimensions in diameter to the elongated portion 32 which is configured to be inserted into or onto the nozzle body 20. The nozzle tip 50 generally includes an attachment portion 52 which is illustrated as a threaded portion 54 and an outer surface 56 having wrench surfaces 58. As described above, the outer surface 56 generally has an outside diameter that is approximately the same or slightly smaller than the outside diameter of the elongated portion 32. The wrench surfaces 58 are also configured to allow easy installation and removal of the nozzle tip 50 from the nozzle body 20. The nozzle tip 50 also includes an inner tip cavity 60 which includes a first portion 62 having tapered inner tip walls and a second portion 64 having substantially straight inner tip walls. The inner tip cavity 60 generally extends between an entrance end 66 and an exit end 68 on the nozzle tip 50. The second portion 64 generally forms or includes what is called the orifice 70 on the nozzle tip 50. The orifice may be formed of any size, shape, or configuration and may even be a separate member formed of any desirable material, including diamond. The tapered first portion wall 62 allows for consistent spray and reduced cavitation and uses an approximately 4° taper or twice the amount of taper as compared to the tapered inner walls 40 on the nozzle body.

The tapered inner walls 40 in the nozzle body and the tapered inner tip walls 62 in the nozzle tip 50 extend some distance apart, to allow for the desired pressures and reduced cavitation to provide consistent, precise, and accurate results. In addition, the reduced diameter of the outer surface of the nozzle tip 50 as well as the elongated portion 32 allows the nozzle body to reach into areas previously not possible and when combined with the structure of the inner cavity 38 and the inner tip cavity 60, allow for a very narrow, elongated nozzle 10 that does not bow or bend under pressure. The length of the elongated inner cavity wall 42 is equal to or greater than the length of tapered portion 28 and more specifically greater than or equal to the sum of the tapered portion 28 and the tapered walls 40.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A high pressure water nozzle comprising:
a nozzle body having an attachment portion, a tapered portion extending from said attachment portion, and an elongated portion extending from said tapered portion;
a inner cavity extending through said nozzle body and wherein said inner cavity includes a tapered inner wall and an elongated inner wall and wherein said tapered inner wall is substantially located within said tapered portion; and
a nozzle tip including an orifice and wherein said nozzle tip is removably coupled to said nozzle body.

2. The high pressure water nozzle of claim 1 wherein said tapered inner wall does not extended into said elongated portion.

3. The high pressure water nozzle of claim 1 wherein said tapered inner wall extends into said attachment portion.

4. The high pressure water nozzle of claim 1 wherein said elongated portion forms between 45% and 75% of said nozzle body.

5. The high pressure water nozzle of claim 4 wherein said elongated portion forms between 50 and 65% of said nozzle body.

6. The high pressure water nozzle of claim 1 wherein said nozzle tip includes an inner nozzle tip cavity and wherein said inner nozzle tip cavity includes tapered inner tip walls.

7. The high pressure water nozzle of claim 6 wherein said tapered inner tip walls form the majority of the length of said inner nozzle tip cavity.

8. The high pressure water nozzle of claim 6 wherein said tapered inner tip walls have an angle of approximately 2-6 degrees.

9. The high pressure water nozzle of claim 6 wherein said tapered inner tip walls have approximately twice the amount of angle of said tapered inner walls.

10. The high pressure water nozzle of claim 1 wherein nozzle tip has a length of less than 20% of the length of said nozzle body.

11. The high pressure water nozzle of claim 1 wherein said nozzle tip includes a tip attachment portion and an outer surface portion including wrench surfaces and wherein said orifice is located within said outer portion.

12. The high pressure water nozzle of claim 11 wherein said nozzle body includes wrench surfaces located at least partially on said tapered portion.

13. The high pressure water nozzle of claim 11 wherein said inner cavity walls include a transition point between said tapered inner walls and said elongated inner walls and wherein said transition point is located within said tapered portion and wherein said elongated inner walls extend at least 15% the length of said tapered portion into said tapered portion.

14. The high pressure water nozzle of claim 13 wherein said elongated inner walls extend at least 40% into said tapered portion.

15. The high pressure water nozzle of claim 1 wherein said tapered inner walls are angled approximately 1-4 degrees.

16. The high pressure water nozzle of claim 1 wherein said elongated portion includes a first outer diameter and said nozzle tip includes a second outer diameter and wherein said second outer diameter is substantially equal to or less than said first outer diameter.
